(19) United States
(12) Patent Application Publication
(10) Pub. No.: US 2022/0125026 A1
(43) Pub. Date: Apr. 28, 2022

(54) Interchangeable Illuminated Fishing Lure

(71) Applicant: Christopher James Wilde, Bailey, MI (US)

(72) Inventor: Christopher James Wilde, Bailey, MI (US)

(21) Appl. No.: 17/079,496

(22) Filed: Oct. 25, 2020

(51) Int. Cl. A01K 85/01; A01K 85/18

(52) U.S. Cl. CPC A01K 85/01; A01K 85/18

(57) ABSTRACT

The improved interchangeable illuminated fishing lure is comprised of two hollow light-transmissive polymer bodies creating a resealable watertight housing allowing for interchangeable power and illumination sources. Each body detachably engages another body with a watertight fastening means. The illumination assembly pocket provides temporary securement where the positive and negative leads of the illumination source are held in contact against the power source terminals illuminating the lure and allowing for rapid interchangeability of illumination color, brightness, or light effects such as blinking, flashing, flickering or like.

### CROSS REFERENCE TO RELATED APPLICATIONS

This application claims priority to Provisional Patent Application No. 62/925,851 filed Oct. 25, 2019, entitled “INTERCHANGEABLE MODULAR FISHING LURE” which is incorporated by reference for all purposes.

### BACKGROUND OF THE INVENTION

### Field of the Invention

This invention relates to fishing lures and more particularly to interchangeably illuminated fishing lures.

### Description of Prior Art

The use of lures for fishing is well known by anglers all over the world. Lures utilize different fixed sensory attractants such as illumination to gain the attention of fish to entice a bite with the goal resulting in a catch. Each sensory attractant has an advantage or disadvantage based on but not limited to variables such as water type, water condition, water visibility, desired angling depth, the presence or lack thereof structure or plant life, targeted fish species, prey species, availability of prey species, barometric pressure, and other environmental conditions.

Devises in prior art typically include at least one or more permanently affixed attributes such as circuitry, power source, or illumination sources. Some devices incorporate permanently affixed attributes in a sealed body. In both examples, due to said variables listed it is impossible to match the optimal illumination configuration to the present conditions without interchangeability.

Therefore, a need exists for an interchangeable illuminated fishing lure that would allow for rapid interchangeability of illumination color, brightness, or light effects such as blinking, flashing, flickering, or like.

### SUMMARY OF THE INVENTION

It is the intent of this invention to provide an improved, interchangeable, illuminated fishing lure. The interchangeable illuminated fishing lure is made from two hollow, light transmissive hard polymer bodies. These bodies are rotationally joined using threading and sealed watertight with a gasket interposed. Affixed within at least one or more bodies is an illumination assembly pocket that created temporary securement for a power and illumination source. The pocket consists of a cavity enabling the temporary securement of the power source and an indented slot on a minimum of two walls of the pocket providing temporary securement of the illumination source against the power source illuminating the lure. The temporary securement of the illumination assembly pocket also allows for the rapid interchangeability of power sources and illumination sources creating many variations.

### BRIEF DESCRIPTION OF THE DRAWINGS

FIG. 1 is an isometric view of the first embodiment of an improved interchangeable illuminated fishing lure.

FIG. 2 is an isometric view of the Second embodiment of an improved interchangeable illuminated fishing lure.

FIG. 3 is an exploded top view cross-section of the improved interchangeable illuminated fishing lure in FIG. 1 with the power and illumination source.

FIG. 4 is an exploded right-side view cross section of the improved interchangeable illuminated fishing lure in FIG. 1 with the power and illumination source in place.

FIG. 5 is an exploded right-side view cross section of the improved interchangeable illuminated fishing lure in FIG. 1 with the power and illumination source remove to show the illumination assembly pocket.

FIG. 6 is a front view of the trailing body showing the illumination assembly pocket of the improved interchangeable illuminated fishing lure in FIG. 1

FIG. 7 is a top view cross-section of the improved interchangeable illuminated fishing lure in FIG. 2 with the power and illumination source.

FIG. 8 is a right-side view cross section of the improved interchangeable illuminated fishing lure in FIG. 2 with the power and illumination source in place.

FIG. 9 is a rear isometric view of the leading body of the improved interchangeable illuminated fishing lure in FIG. 2 with the power and illumination source in place.

FIG. 10 is a rear view of the improved interchangeable illuminated fishing lure in FIG. 2 with the power and illumination source removed to show the illumination assembly pocket.

### DETAILED DESCRIPTION OF THE DRAWINGS

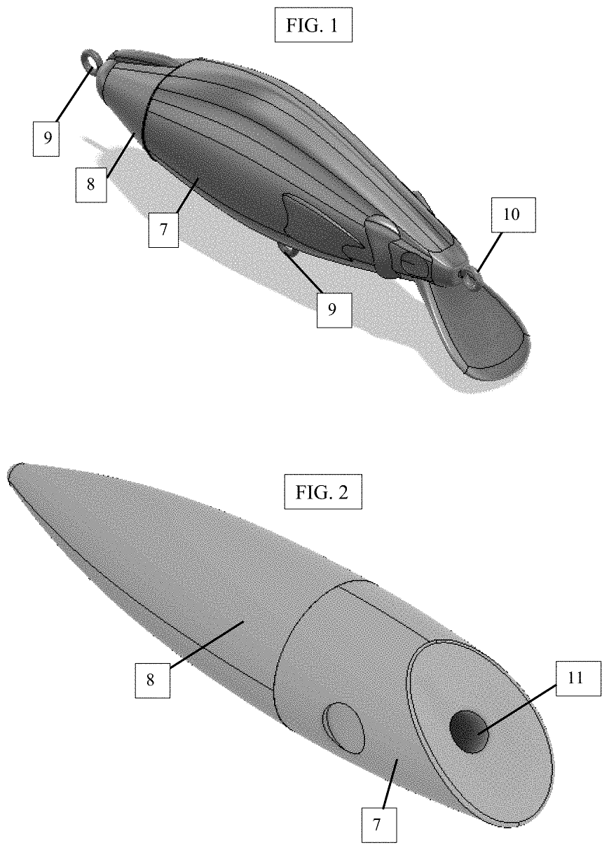

The embodiments described herein relate to the improved interchangeable illuminated fishing lure where the power and illumination source can be easily detached and interchanged with numerous options allowing for rapid interchangeability of illumination color, brightness, or light effects such as blinking, flashing, flickering or like. In FIG. 1 the first embodiment of the interchangeable illuminated fishing lure includes a hollow light-transmissive hard polymer leading body (7) and a trailing body (8) connected in an isometric view. In the FIG. 1 embodiment the hooks are connected to the body through multiple eyelets (9) and the line is connected through the front eyelet (10).

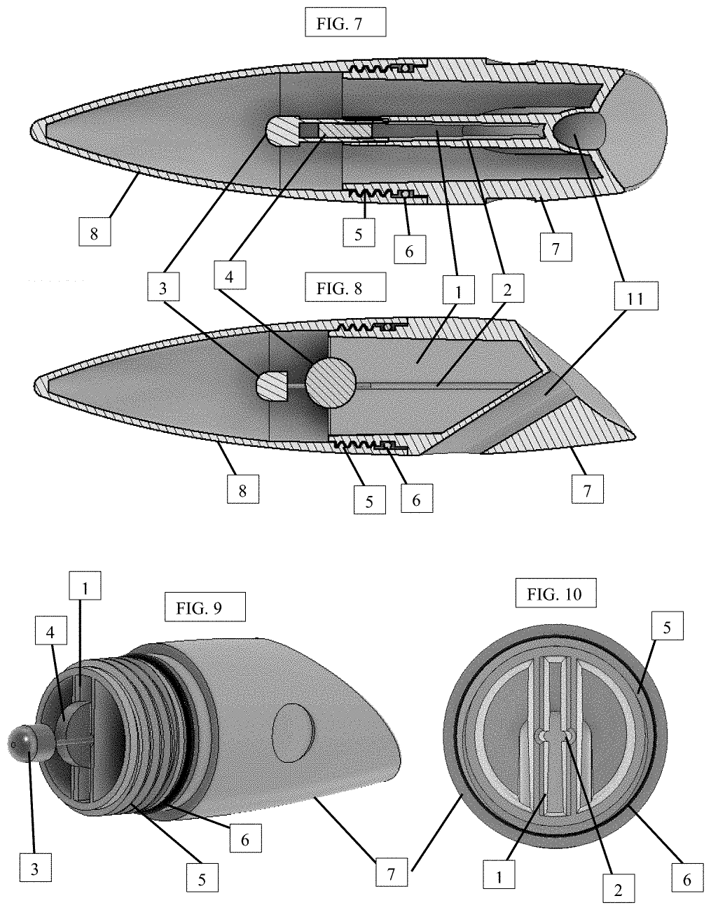

Like in FIG. 1 the second embodiment of the interchangeable illuminated fishing lure in FIG. 2 includes a hollow light-transmissive hard polymer leading body (7) and a trailing body (8) connected in an isometric view. Also shown in FIG. 2 is a secondary means for incorporating hooks and a line tie. The hook harness aperture (11) is a sealed tube running completely through the leading body (7). The hook harness is slid through the harness aperture (11) from the bottom of the lure to the top then allowing the fishing line to be tied to the harness holding the interchangeable illuminated fishing lure of FIG. 2 in place on the line while under use within the water. The hook harness aperture can also be seen in FIGS. 7-8 and 10.

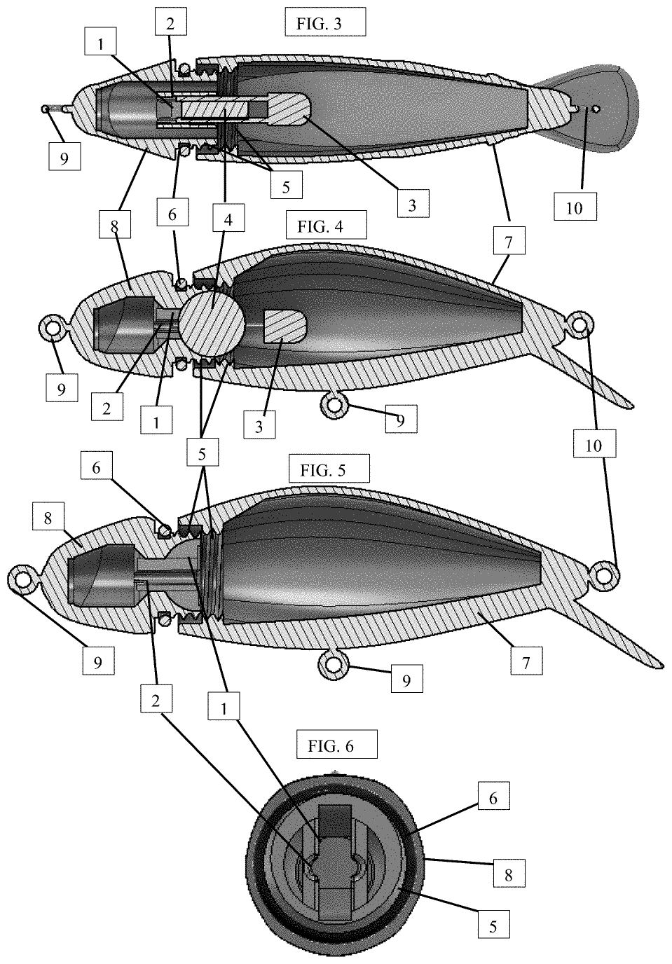

The exploded views in FIGS. 3-4 shows the cross-section of the top and right side of the interchangeable illuminated fishing lure in FIG. 1. The leading body (7) and trailing body (8) are rotationally connected by threading (5) and an interposed gasket (6) to form a watertight seal. Further included in FIGS. 3-4 are the power source (4) and illumination source (3) seated into the illumination assembly pocket (1). The walls of the illumination assembly pocket (1) are tapered with the larger opening facing the transverse plane of the interchangeable illuminated fishing lure of FIG. 1 causing the illumination assembly pocket (1) to narrow as the power source (4) is inserted. The tapered walls of the illumination assembly pocket (1) allow temporary securement for the differing sized power sources (4) to be utilized within the same lure such as the various types of coin cell batteries. It also allows for the ease of inserting and removing of the power source (4) when changes are needed based on various conditions. At least two walls of the illumination assembly pocket (1) have a slot indention (2) for the temporary securement of the positive and negative leads of the illumination source (3) such as the anode and cathode of a light emitting diode against the appropriate terminals of the power source (4) illuminating the lure.

In FIG. 5 a right-side view cross-section of the interchangeable illuminated fishing lure of FIG. 1 whereas the power source (4) and illumination source (3) of FIGS. 3-4 are removed showing the illumination assembly pocket (1) and an example of the slot indention (2) creating the temporary securement of the illumination source.

FIG. 6 is a front view of the trailing body showing the illumination assembly pocket of the improved interchangeable illuminated fishing lure in FIG. 1 highlighting the illumination assembly pocket (1), an example of slot indentions (2) within the illumination assembly pocket (1), threading (5) and a interposed gasket (6). In the embodiment of the interchangeable illuminated fishing lure of FIG. 1 the illumination assembly pocket (1) is internally secured to the trailing body (8).

FIGS. 7-8 shows the top and right view cross-section of the interchangeable illuminated fishing lure in FIG. 2. In FIGS. 7-10 the illumination assembly pocket (1) is internally secured to the leading body (7) instead of the trailing body (8) as shown in FIGS. 3-6. The illumination assembly pocket can be internally secured to either the leading body or the trailing body or in some embodiments both bodies. FIGS. 3-5 demonstrates the illumination assembly pocket (1) does not reach the full extent of the body horizontally while FIGS. 7-8 demonstrate the illumination assembly pocket extending to the full extent horizontally to.

FIG. 10 is a rear view of the improved interchangeable illuminated fishing lure in FIG. 2 with the power and illumination source removed to show the illumination assembly pocket (1).

It will be appreciated that, although specific embodiments of the invention have been described herein for purposes of illustration, various modifications may be made without departing from the spirit and scope of the invention. Accordingly, the invention is not limited except as by the appended claims.

What is claimed is:

1. An improved illuminated fishing lure comprising: a leading and trailing hollow body each having an open-ended cavity joinable by a watertight fastening means; at least one illumination assembly pocket; at least one detachable power source; at least one detachable illumination source; at least one or more hooks assemblies and line tie

2. The improved illuminated fishing lure of claim 1 wherein said bodies are comprised of a light-transmissive polymer.

3. The improved illuminated fishing lure of claim 1 wherein said watertight fastening means comprises of threading between said bodies with an interposed gasket.

4. The improved illuminated fishing lure of claim 1 wherein said illumination assembly pocket is internally secured to one or more said bodies with the opening of said illumination assembly pocket facing the transverse plane of said improved illuminated fishing lure.

5. The improved illuminated fishing lure of claim 4 wherein said illumination assembly pocket is comprised of a plurality of walls creating temporary securement of said detachable power source.

6. The improved illuminated fishing lure of claim 5 wherein said illumination assembly pocket is comprised from said plurality of walls wherein at least two walls have an indented slot for the temporary securement of the positive and negative leads of the said detachable illumination source against the said detachable power source connecting the circuit and illuminating the said fishing lure.

7. The improved illuminated fishing lure of claim 1 wherein one or more said hooks are affixed to one or more said bodies with one or more eyelets.

8. The improved illuminated fishing lure of claim 1 wherein an aperture diagonally slanted through the leading body to affix a hook harness.
